(19) United States
(12) Patent Application Publication
(10) Pub. No.: US 2026/0254664 A1
(43) Pub. Date: Aug. 27, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Seishiro KAWAMURA, Osaka (JP); Ayaka NAKASAKA, Osaka (JP); Yuji UNAGAMI, Osaka (JP)

(21) Appl. No.: 19/650,712

(22) Filed: Apr. 17, 2026

Related U.S. Application Data
(63) Continuation of application No. PCT/JP2024/036935, filed on Oct. 17, 2024.
(60) Provisional application No. 63/545,979, filed on Oct. 27, 2023.

(51) Int. Cl. H04L 9/00

(52) U.S. Cl. CPC H04L 9/50

(57) ABSTRACT

An information processing method includes: obtaining first data; applying noise to second data that is based on the first data; and managing, on a public blockchain, third data that is based on the second data to which the noise has been applied, and managing the second data on a private blockchain.

### CROSS REFERENCE TO RELATED APPLICATIONS

This is a continuation application of PCT International Application No. PCT/JP2024/036935 filed on October 17, 2024, designating the United States of America, which is based on and claims priority of U.S. Provisional Patent Application No. 63/545,979 filed on October 27, 2023. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

Conventionally, various types of information have been recorded and managed in distributed ledgers. For example, Non-Patent Literature (NPL) 1 discloses a technique for storing noise-added data on a blockchain.

### CITATION LIST

### Non Patent Literature

NPL 1: Wenchao Jiang, et al. “Privacy Budget Management and Noise Reusing in Multichain Environment.” International Journal of Intelligent Systems - Wiley Online Library, 2022, https://onlinelibrary.wiley.com/doi/full/10.1002/int.22619. Accessed September 13, 2024.

### SUMMARY

### Technical Problem

There is a risk that confidential information of a company or the like may leak from public data available on a blockchain. For example, combining a plurality of public data items available on the blockchain may lead to information leakage.

In view of this, the present disclosure provides an information processing method, an information processing device, and a recording medium capable of suppressing information leakage from public data available on a blockchain.

### Solution to Problem

An information processing method according to an aspect of the present disclosure includes: obtaining first data; applying noise to second data that is based on the first data; and managing, on a public blockchain, third data that is based on the second data to which the noise has been applied, and managing the second data on a private blockchain.

An information processing device according to an aspect of the present disclosure includes: an obtainer that obtains first data; a noise applier that applies noise to second data that is based on the first data; and a controller that performs control to manage, on a public blockchain, third data that is based on the second data to which the noise has been applied, and manage the second data on a private blockchain.

A recording medium according to an aspect of the present disclosure is a non-transitory computer-readable recording medium having recorded thereon a program for causing a computer to execute the information processing method described above.

### Advantageous Effects

According to an aspect of the present disclosure, it is possible to implement an information processing method and the like that are capable of suppressing information leakage from public data available on a blockchain.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating a configuration of an information processing system according to an embodiment.

FIG. 2 is a block diagram illustrating a functional configuration of a ledger server included in a first distributed ledger system according to an embodiment.

FIG. 3 is a block diagram illustrating a functional configuration of a ledger server included in a second distributed ledger system according to an embodiment.

FIG. 4 is a diagram for describing quantification of the amount of CO₂ emissions at each stage of the entire supply chain.

FIG. 5 is a diagram illustrating a table used for calculating the amount of CO₂ emissions according to an embodiment.

FIG. 6A is a diagram illustrating the average amount of CO₂ emissions per unit according to an embodiment.

FIG. 6B illustrates the average amount of CO₂ emissions per unit according to an embodiment when the number of mining companies has changed.

FIG. 7 is a diagram illustrating the total amount of CO₂ emissions according to an embodiment.

FIG. 8 is a sequence diagram illustrating operation of an information processing system according to an embodiment.

FIG. 9A is a diagram illustrating the amount of CO₂ emissions per unit stored in the database generated in step S10 illustrated in FIG. 8.

FIG. 9B is a diagram illustrating the total amount of CO₂ emissions stored in the database generated in step S10 illustrated in FIG. 8.

FIG. 10A is a diagram illustrating an example of the average amount of CO₂ emissions per unit to which noise has been applied.

FIG. 10B is a diagram illustrating an example of the total amount of CO₂ emissions to which noise has been applied.

FIG. 11 is a sequence diagram illustrating operation of an information processing system according to Variation 1 of an embodiment.

FIG. 12 is a sequence diagram illustrating operation of an information processing system according to Variation 2 of an embodiment.

FIG. 13 is a diagram illustrating the amount of CO₂ emissions per unit to which noise has been applied in step S71 illustrated in FIG. 12.

FIG. 14 is an explanatory diagram illustrating a data structure of a blockchain.

FIG. 15 is an explanatory diagram illustrating a data structure of transaction data.

FIG. 16 is an explanatory diagram illustrating transaction data pertaining to execution of a smart contract.

FIG. 17 is an explanatory diagram illustrating processing pertaining to execution of a smart contract.

FIG. 18 is an explanatory diagram illustrating structures of an NFT and metadata.

### DESCRIPTION OF EMBODIMENTS

An information processing method according to a first aspect of the present disclosure includes: obtaining first data; applying noise to second data that is based on the first data; and managing, on a public blockchain, third data that is based on the second data to which the noise has been applied, and managing the second data on a private blockchain.

Accordingly, the data managed on the public blockchain, that is, publicly disclosed data, is data to which noise has been applied. For example, combining a company’s data to which noise has been applied and the company’s other data makes it more difficult to obtain information not publicly disclosed by the company, as compared to the case of combining the company’s data to which noise is not applied and the company’s other data. It is therefore possible to suppress leakage of information not publicly disclosed by a company or the like from public data available on a blockchain.

Because information leakage is suppressed, data providers can provide their data without concern, and the likelihood that the data providers provide their data to data users increases.

In addition, for example, an information processing method according to a second aspect is the information processing method according to the first aspect and may further include: when transaction data that requests generation of predetermined information that is based on the first data is obtained, generating the predetermined information, based on the third data; and transmitting the predetermined information generated.

Accordingly, since the predetermined information is generated based on the data to which noise has been applied, the predetermined information makes it possible to suppress leakage of information not publicly disclosed by the company or the like.

In addition, for example, an information processing method according to a third aspect is the information processing method according to the second aspect, in which the first data may be obtained from a second company upstream of a first company, the first company and the second company being among companies included in a supply chain, and the transaction data may be obtained from the first company.

Accordingly, it is possible to suppress leakage of information on an upstream company in a supply chain to a downstream company.

In addition, for example, an information processing method according to a fourth aspect is the information processing method according to any one of the first through third aspects, in which the noise may include noise that satisfies differential privacy.

Accordingly, applying noise that satisfies differential privacy makes it possible to effectively suppress leakage of information not publicly disclosed by a company or the like from public data available on a blockchain.

In addition, for example, an information processing method according to a fifth aspect is the information processing method according to any one of the first through fourth aspects, in which the second data may be the first data, and the information processing method may further include: performing statistical processing on the second data to which the noise has been applied; and managing, on the public blockchain, the second data to which the noise has been applied and on which the statistical processing has been performed, the second data being managed as the third data.

Accordingly, a system that applies noise to data before performing statistical processing can suppress leakage of information not publicly disclosed by a company or the like.

In addition, for example, an information processing method according to a sixth aspect is the information processing method according to any one of the first through fifth aspects, and may further include: calculating the second data by performing statistical processing on the first data.

Accordingly, since the number of data items to which noise is applied decreases as compared to the case of applying noise to the first data, it is possible to reduce the amount of processing required for applying noise.

In addition, for example, an information processing method according to a seventh aspect is the information processing method according to any one of the first through sixth aspects, in which the first data may include data related to an amount of greenhouse gas emissions.

Accordingly, it is possible to suppress leakage of information related to a greenhouse gas.

In addition, an information processing device according to an eighth aspect of the present disclosure includes: an obtainer that obtains first data; a noise applier that applies noise to second data that is based on the first data; and a controller that performs control to manage, on a public blockchain, third data that is based on the second data to which the noise has been applied, and manage the second data on a private blockchain.

Accordingly, the same advantageous effects as those of the above-described information processing method are provided.

In addition, a recording medium according to a ninth aspect of the present disclosure is a non-transitory computer-readable recording medium having recorded thereon a program for causing a computer to execute the information processing method according to any one of the first through seventh aspects.

Accordingly, the same advantageous effects as those of the above-described information processing method are provided.

Note that these general or specific aspects may be implemented using a system, a method, an integrated circuit, a computer program, or a non-transitory computer-readable recording medium such as a compact disc read-only memory (CD-ROM), or any combination of systems, methods, integrated circuits, computer programs, or recording media. The program may be recorded on a recording medium in advance or may be supplied to a recording medium via a wide area communication network such as the Internet.

Hereinafter, exemplary embodiments will be specifically described with reference to the accompanying Drawings.

Note that each of the exemplary embodiments described below shows a general or specific example. The numerical values, constituent elements, the arrangement and connection of the constituent elements, steps, the processing order of the steps etc. shown in the following exemplary embodiments are mere examples, and are therefore not intended to limit the present disclosure. Further, among the constituent elements in the following exemplary embodiments, those not recited in any one of the independent claims will be described as optional constituent elements.

Furthermore, the Drawings are represented schematically and are not necessarily precise illustrations. In addition, constituent elements that are substantially the same are given the same reference signs in the Drawings, and redundant descriptions thereof will be omitted or simplified.

In the present Specification, terms indicating relationships between elements, such as “same”, numerical values, and numerical value ranges include, in addition to their exact meanings, substantially equivalent ranges including deviations of approximately a few percent (or approximately 10%), for example.

In the present Specification, ordinal numbers such as “first” and “second” are used not to imply a specific number or order of constituent elements unless specifically stated otherwise, but rather to avoid confusion among similar constituent elements and to distinguish them.

### EMBODIMENT

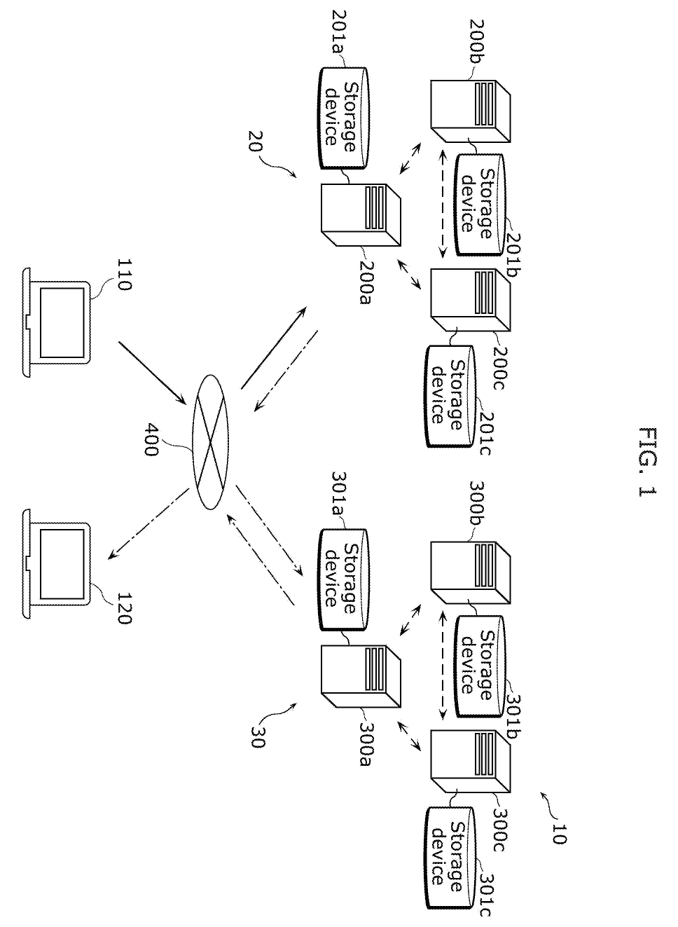

Hereinafter, an information processing system according to the present embodiment will be described with reference to FIG. 1 through FIG. 18.

### 1. Configuration of Information Processing System

First, a configuration of the information processing system according to the present embodiment will be described with reference to FIG. 1 through FIG. 7. FIG. 1 is a diagram illustrating a configuration of information processing system 10 according to the present embodiment. In FIG. 1, solid arrows indicate exchange of raw data (data to which noise is not applied), whereas dashed arrows indicate exchange of data to which noise has been applied.

As illustrated in FIG. 1, information processing system 10 includes, for example, data provider terminal 110, data user terminal 120, ledger servers 200a, 200b, 200c, and ledger servers 300a, 300b, 300c. These are communicatively connected to each other by communication network 400.

Hereinafter, ledger servers 200a, 200b, 200c are also referred to as “ledger servers 200a etc.”, and ledger servers 300a, 300b, 300c are also referred to as “ledger servers 300a etc.” Further, storage devices 201a, 201b, 201c are also referred to as “storage devices 201a etc.”, and storage devices 301a, 301b, 301c are also referred to as “storage devices 301a etc.”

Ledger servers 200a etc. are connected to storage devices 201a etc. Ledger servers 200a etc. may be connected to storage devices 201aetc. via communication network 400 or may internally include storage devices 201a etc. Storage devices 201a etc. each include a distributed ledger on which transaction data and blocks of a blockchain are electrically recorded. Ledger servers 200a, 200b, 200c form first distributed ledger system 20.

Note that the blockchain in first distributed ledger system 20 is a private blockchain with restricted participation, such as a private-type or consortium-type blockchain. That is, data stored on the distributed ledgers of first distributed ledger system 20 is not publicly disclosed and can be viewed only by users having an access right.

Ledger servers 300a etc. are connected to storage devices 301a etc. Ledger servers 300aetc. may be connected to storage devices 301aetc. via communication network 400 or may internally include storage devices 301a etc. Storage devices 301aetc. each include a distributed ledger on which transaction data and blocks of a blockchain are electrically recorded. Ledger servers 300a, 300b, 300cform second distributed ledger system 30.

Note that the blockchain in second distributed ledger system 30 is a public blockchain with unrestricted participation, such as a public-type blockchain. That is, data stored on the distributed ledgers of second distributed ledger system 30 is publicly disclosed and can be viewed by anyone.

In the present embodiment, first distributed ledger system 20 and second distributed ledger system 30 manage data related to each other. Each of first distributed ledger system 20 and second distributed ledger system 30 performs distributed ledger management using a blockchain. Note that the number of ledger servers included in each distributed ledger system is not limited to three, provided that at least one ledger server is included.

Data provider terminal 110 is an information processing device possessed by a first user (data provider) who stores predetermined data on a distributed ledger. Data provider terminal 110 is an information processing device having the access right to access the data stored on the distributed ledgers of first distributed ledger system 20. Data provider terminal 110 is permitted to transmit transaction data to the blockchain.

Data provider terminal 110 includes, for example: a communication unit through which communication is performed with ledger server 200a via communication network 400; a receiver that receives an operation (input) from the first user; and a transaction data generator that generates transaction data to be stored on the blockchain, based on data etc. obtained from the receiver. Data provider terminal 110 includes a processor and a memory, for example. The memory is read-only memory (ROM), random-access memory (RAM), or the like, and can store a program executed by the processor. Each function of data provider terminal 110 is achieved by, for example, the processor that executes the program stored in the memory. The communication unit may include, for example, a communication circuit (or a communication module), and the receiver may include a touch panel, a button, a sound collection device, and so on. Data provider terminal 110 may be implemented by a stationary personal computer (PC), a mobile terminal such as a smartphone or a tablet, a server, or the like.

Data user terminal 120 is an information processing device possessed by a second user (data user) who uses data stored on a distributed ledger. Data user terminal 120 is an information processing device that does not have the access right to access the data stored on the distributed ledgers of first distributed ledger system 20. Note that data user terminal 120 may be capable of transmitting transaction data to ledger server 200a.

Data user terminal 120 includes, for example: a communication unit through which communication is performed with ledger server 300a via communication network 400; and a receiver that receives an operation (input) from the second user. Data user terminal 120 includes a processor and a memory, for example. The memory is ROM, RAM, or the like, and can store a program executed by the processor. Each function of data user terminal 120 is achieved by, for example, the processor that executes the program stored in the memory. The communication unit may include, for example, a communication circuit (or a communication module), and the receiver may include a touch panel, a button, a sound collection device, and so on. Data user terminal 120 may be implemented by a stationary personal computer (PC), a mobile terminal such as a smartphone or a tablet, a server, or the like.

First distributed ledger system 20 includes ledger servers 200a, 200b, and 200c as a server group holding distributed ledgers. When at least one of ledger servers 200aetc. receives transaction data, the transaction data is shared by all ledger servers 200a etc. and stored on the distributed ledgers.

Ledger server 200a is a computer (server) that holds and manages a distributed ledger. Ledger server 200aholds distributed ledger 1026aand updates the distributed ledger in synchronization with the other ledger servers (specifically, ledger servers 200b and 200c).

Ledger servers 200b and 200c are servers similar to ledger server 200a and operate independently of ledger server 200a.

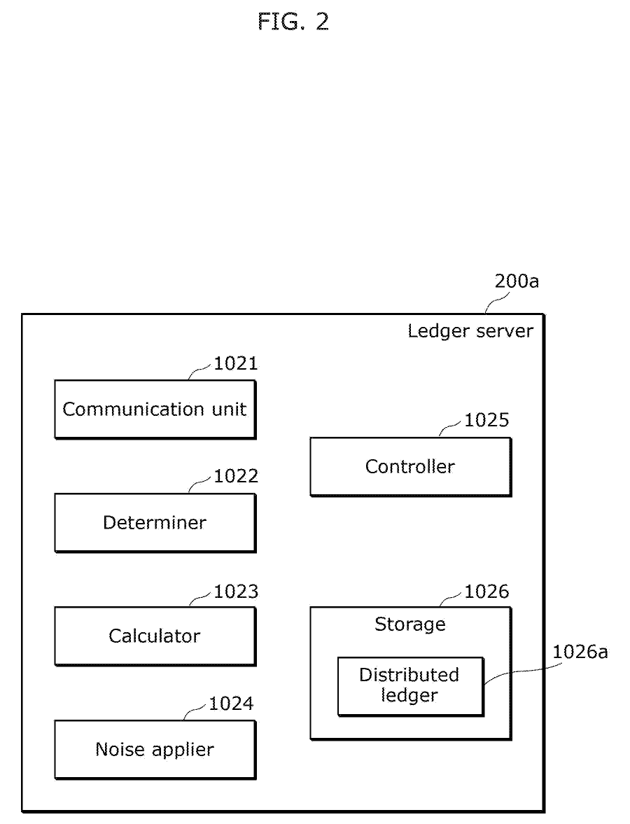

FIG. 2 is a block diagram illustrating a functional configuration of ledger server 200a included in first distributed ledger system 20 according to the present embodiment. Since the configurations of ledger servers 200band 200c are similar to that of ledger server 200a, ledger server 200a will be described as an example. Note that FIG. 2 illustrates an exemplary functional configuration of ledger server 200a, and the functional configuration of ledger server 200a is not limited to FIG. 2.

As illustrated in FIG. 2, ledger server 200a includes communication unit 1021, determiner 1022, calculator 1023, noise applier 1024, controller 1025, and storage 1026. Ledger server 200a also includes a ledger manager and an executor (not illustrated). At least one of the functional units included in ledger server 200a is implemented by a processor (for example, a central processing unit (CPU)) included in ledger server 200a, executing a program using a memory.

Communication unit 1021 is a communication interface communicatively connected to communication network 400. Communication unit 1021 may be a communication interface conforming to a wired communication standard (for example, Ethernet (registered trademark), etc.) or may be a communication interface conforming to a wireless communication standard (for example, Wi-Fi (registered trademark) etc. or a mobile communications system (3G, 4G, or 5G, etc.)). Communication unit 1021 is used when the functional units included in ledger server 200a communicate with other devices. For example, communication unit 1021 is used when the functional units included in ledger server 200a communicate with any one of data provider terminal 110, data user terminal 120, ledger servers 200b and 200c, and ledger servers 300a etc.

Communication unit 1021 functions as the obtainer that obtains first data, for example.

Determiner 1022 determines a parameter for adding noise to data. In the present embodiment, determiner 1022 determines privacy strength ε for adding noise that satisfies differential privacy. Differential privacy defines privacy based on the concept that a query to a database is considered safe if the result of the query on a database including an individual’s data is indistinguishable from the result of the same query on a database that does not include that individual’s data. Privacy strength ε is, for example, a parameter that determines how close the statistic computed with an individual’s data must be to the statistic computed without that individual’s data in order to ensure safety.

Determiner 1022 determines privacy strength ε in accordance with target data to which noise is to be applied. Determiner 1022 may determine privacy strength ε based on an attribute of the target data, for example. Attributes of the target data include, for example, the type of data (the amount of carbon dioxide (CO₂) emissions, the sales volume of a target item, etc.), but are not limited to this. The attributes of the target data are obtainable before the target data is actually obtained. Determiner 1022 may determine privacy strength ε before the target data is obtained from data provider terminal 110, or may obtain the target data first and then determine privacy strength ε based on the target data obtained.

Calculator 1023 calculates statistical data by performing predetermined calculation on the target data.

Noise applier 1024 applies noise in accordance with privacy strength ε to the statistical data of the target data or raw data of the target data. The method by which noise applier 1024 applies noise is not particularly limited. For example, the determined noise may be applied using the Laplace mechanism or the Gaussian mechanism.

Controller 1025 performs control of generation and storage of various types of data, for example.

Storage 1026 is a storage device that stores information. Storage 1026 stores distributed ledger 1026a. Storage 1026 is implemented by a nonvolatile storage device (a solid state drive (SSD) or a hard disk drive (HDD)), for example.

Distributed ledger 1026a stores data structured as chained blocks, each including one or more transaction data items. The one or more transaction data items stored on distributed ledger 1026a include transaction data including a contract code of a smart contract, transaction data including an instruction to execute a smart contract, or transaction data including other information.

In the present embodiment, distributed ledger 1026a and the distributed ledgers held by ledger servers 300a etc. are a blockchain.

The ledger manager performs processing related to distributed ledger 1026a and transaction data. Specifically, upon receiving transaction data from, for example, data provider terminal 110, the ledger manager performs control to verify a digital signature included in the received transaction data and store the successfully verified transaction data on distributed ledger 1026a held in storage 1026.

The executor performs information processing. For example, the executor can perform information processing by executing a smart contract using distributed ledger 1026a. Note that, in the case where no smart contract is used, the executor performs information processing according to a normal program code.

Referring again to FIG. 1, second distributed ledger system 30 includes ledger servers 300a, 300b, and 300c as a server group holding distributed ledgers. When at least one of ledger servers 300a etc. receives transaction data, the transaction data is shared by all ledger servers 300a etc. and stored on the distributed ledgers.

Ledger server 300a is a computer (server) that holds and manages a distributed ledger. Ledger server 300a holds distributed ledger 1034a and updates the distributed ledger in synchronization with the other ledger servers (specifically, ledger servers 300b and 300c).

Ledger servers 300b and 300c are servers similar to ledger server 300a and operate independently of ledger server 300a.

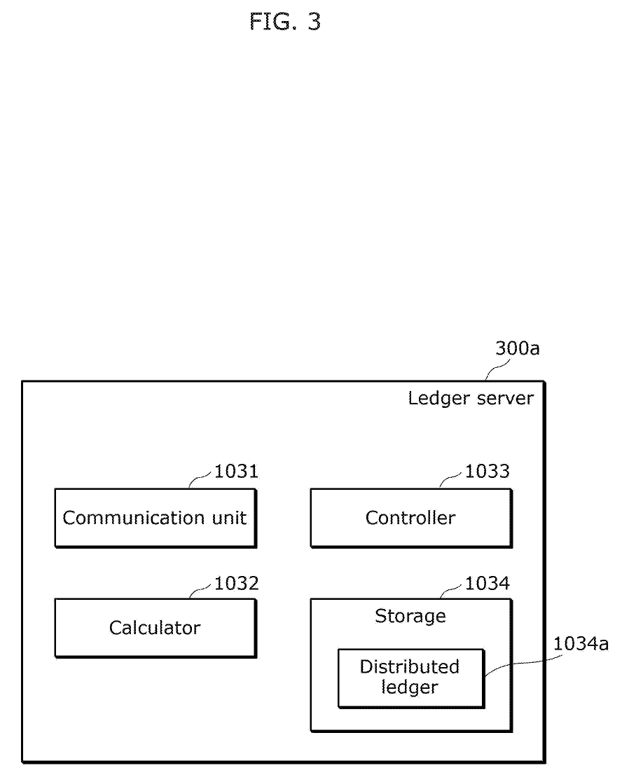

FIG. 3 is a block diagram illustrating a functional configuration of ledger server 300a included in second distributed ledger system 30 according to the present embodiment. Since the configurations of ledger servers 300b and 300c are similar to that of ledger server 300a, ledger server 300a will be described as an example. Note that FIG. 3 illustrates an exemplary functional configuration of ledger server 300a, and the functional configuration of ledger server 300a is not limited to FIG. 3.

As illustrated in FIG. 3, ledger server 300a includes communication unit 1031, calculator 1032, controller 1033, and storage 1034. Ledger server 300a also includes a ledger manager and an executor (not illustrated). At least one of the functional units included in ledger server 300a is implemented by a processor (for example, a CPU) included in ledger server 300a, executing a program using a memory.

Communication unit 1031 is a communication interface communicatively connected to communication network 400. Communication unit 1031 may be a communication interface conforming to a wired communication standard, or may be a communication interface conforming to a wireless communication standard etc. or a mobile communication system. Communication unit 1031 is used when the functional units included in ledger server 300a communicate with other devices.

Calculator 1032 calculates statistical data by performing predetermined calculation on target data.

Controller 1033 performs control of generation and storage of various types of data, for example.

Storage 1034 is a storage device that stores information. Storage 1034 stores distributed ledger 1034a. Storage 1034 is implemented by a nonvolatile storage device (SSD or HDD), for example.

Distributed ledger 1034a stores data structured as chained blocks, each including one or more transaction data items. The one or more transaction data items stored on distributed ledger 1034a include transaction data including a contract code of a smart contract, transaction data including an instruction to execute a smart contract, or transaction data including other information.

Note that the configuration of ledger server 300a may be, for example, the configuration illustrated in FIG. 2.

Here, an example of information managed in information processing system 10 will be described with reference to FIG. 4 through FIG. 7. FIG. 4 is a diagram for describing quantification of the amount of CO₂ emissions at each stage of the entire supply chain. The following describes an example in which data related to the amount of CO₂ emissions is stored on a distributed ledger. The data related to the amount of CO₂ emissions is an example of the data related to the amount of greenhouse gas emissions.

As illustrated in FIG. 4, in order for assembly manufacturer X to manufacture a product, company D conducts mining, company C conducts smelting, company B conducts transportation, company A conducts assembly, and assembled component a is delivered to assembly manufacturer X. At each stage, CO₂ is emitted.

In recent years, as part of sustainability initiatives, it has become common to quantify greenhouse gas (GHG) emissions, including CO₂, over the entire life cycle of a product—from its production to its disposal. Accordingly, it is required to quantify the amount of CO₂ emissions at each stage of the entire supply chain. In addition, companies are required to disclose to other companies etc. how much CO₂ they have emitted.

For example, the amount of CO₂ emissions resulting from the procurement of component a can be calculated by multiplying activity data indicating the amount of component a procured, by an emission factor indicating the amount of CO₂ emitted during the manufacture of one unit of component a. For example, the amount of CO₂ emissions from company D can be calculated by multiplying the amount of ore mined by company D (an example of activity data) by an emission factor. Note that emission factors are publicly disclosed information.

The activity data is information directly linked with the company’s production activities and could be confidential information. Therefore, the activity data is often not publicly available on the blockchain and must not leak to other companies etc. (must remain confidential). Note that, in addition to the confidential information, personal information and the like can also be included in the data that must not leak.

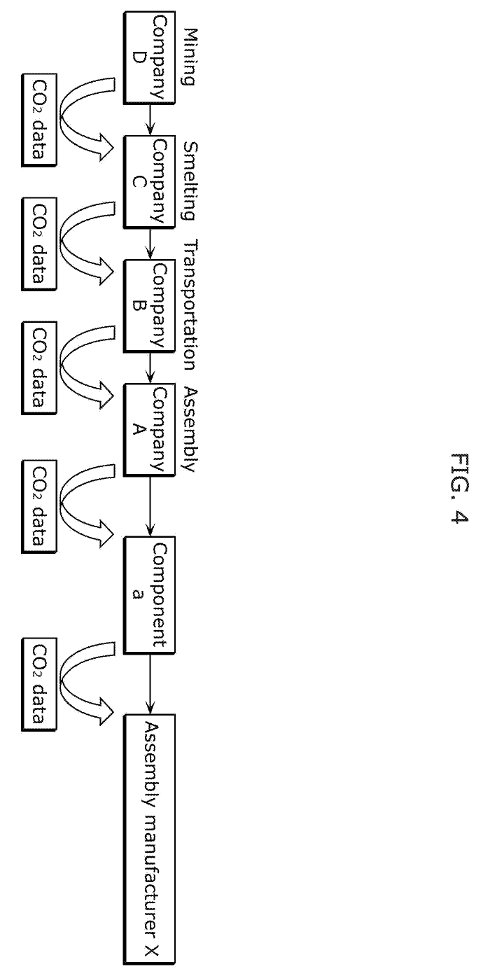

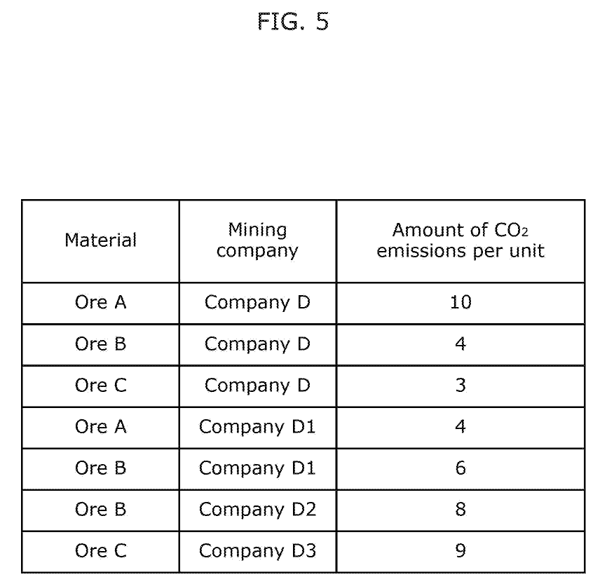

Leakage of activity data, which is an example of the confidential information, will be described with reference to FIG. 5 through FIG. 7.

FIG. 5 is a diagram illustrating information used for calculating the amount of CO₂ emissions according to the present embodiment. FIG. 5 illustrates the CO₂ emissions per unit of each material at mining companies that conduct mining. Note that company D is the most upstream company in the supply chain, whereas assembly manufacturer X is the most downstream company in the supply chain.

As illustrated in FIG. 5, materials, mining companies, and the amounts of CO₂ emissions per unit are associated with each other in the information. The materials indicate ores that are mined, namely ores A, B, and C. For example, ore C is mined by two companies, namely company D and company D3, and the amount of CO₂ emissions per unit when company D conducts mining is 3, whereas the amount of CO₂ emissions per unit when company D3 conducts mining is 9. This information is obtained from data provider terminal 110, for example. Note that the materials mined by each mining company may be publicly disclosed, but the amount of CO₂ emissions per unit of each material is not publicly disclosed.

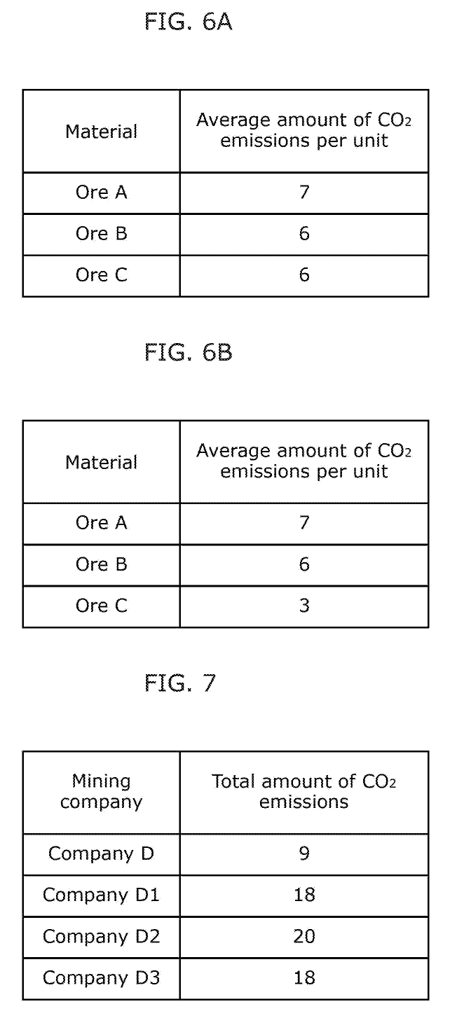

FIG. 6A and FIG. 6B are diagrams each illustrating the average amount (average value) of CO₂ emissions per unit according to the present embodiment. FIG. 7 is a diagram illustrating the total amount of CO₂ emissions according to the present embodiment. For example, the average amount of CO₂ emissions per unit and the total amount of CO₂ emissions are data publicly disclosed on the blockchain, for example (public data). Note that the public data may be publicly disclosed on the blockchain, a database, or a website.

FIG. 6A illustrates the average amount of CO₂ emissions per unit of each material mined by the mining companies indicated in FIG. 5. For example, since ore C is mined by company D and company D3, the average amount of CO₂ emissions per unit of ore C is the average of 3 and 9, which is 6.

FIG. 6B illustrates the average amount of CO₂ emissions per unit of each material when company D3 is no longer included among the mining companies indicated in FIG. 5.

As illustrated in FIG. 6A and FIG. 6B, the average amount of CO₂ emissions per unit of ore C changes depending on whether company D3 is included. If it is publicly disclosed which materials are mined by the mining companies or if it becomes known that company D3 no longer mines ore C, the amount of CO₂ emissions per unit of each of company D and company D3 can be identified. For example, company C, which is downstream of company D, can identify the amount of CO₂ emissions per unit of each of company D and company D3 based on the public data.

In addition, as illustrated in FIG. 7, since the total amount of CO₂ emissions of each of company D and company D3 is publicly disclosed, company C can obtain the total amount of CO₂ emissions of each of company D and company D3.

In such a manner, company C can obtain, for example, the amount of CO₂ emissions per unit and the total amount of CO₂ emissions of company D3 and predict the activity data of company D3 based on these two items of information. For example, company C can predict the activity data of company D3 by dividing the total amount of CO₂ emissions by the amount of CO₂ emissions per unit. That is to say, there is a risk that the activity data which company D3 wishes to keep confidential may leak to company C.

In view of this, according to the present disclosure, noise that satisfies differential privacy is applied to the data obtained by ledger server 200a from data provider terminal 110 (raw data) or to the average amount of CO₂ emissions per unit, and only the data to which noise has been applied is publicly disclosed. Accordingly, whether or not company D3 is included among the mining companies is less likely to alter the public data (for example, statistical data), and it is therefore possible to suppress leakage of the amount of CO₂ emissions per unit at company D3 to other companies such as company C.

[2. Operation of Information Processing System]

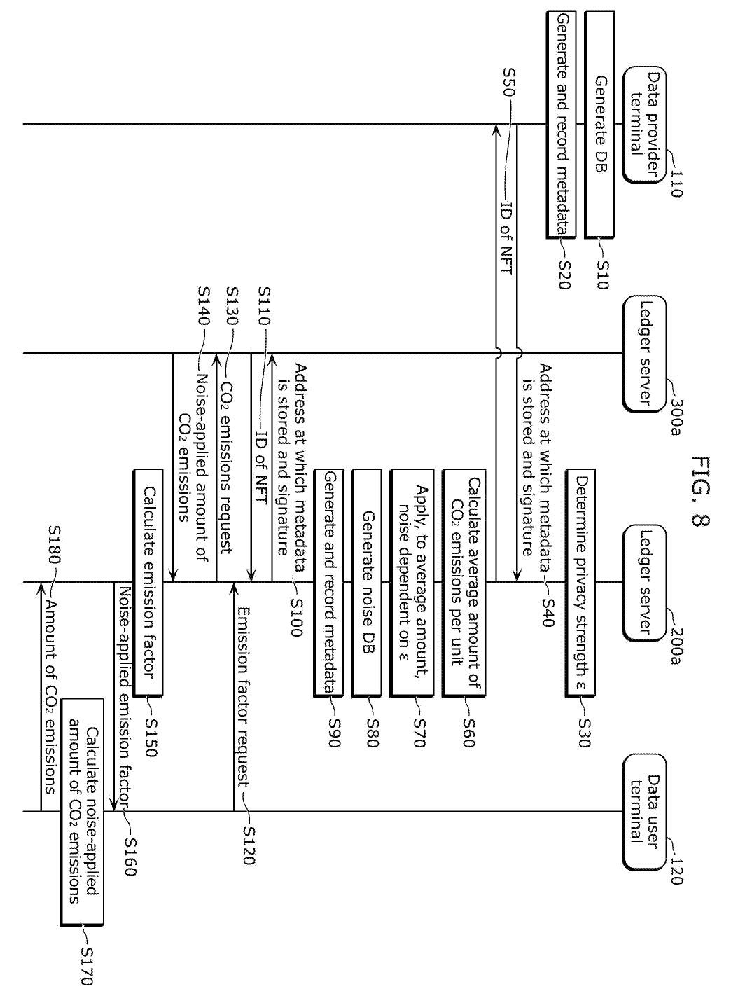

Now, operation of information processing system 10 configured as described above will be described with reference to FIG. 8 through FIG. 13. FIG. 8 is a sequence diagram illustrating operation (an information processing method) of information processing system 10 according to the present embodiment. FIG. 8 illustrates an example in which data provider terminal 110 is a terminal device possessed by a mining company (company D, companies D1 through D3) and data user terminal 120 is an information terminal possessed by a smelting company (company C). The mining company is an example of the second company, and the smelting company is an example of the first company.

As illustrated in FIG. 8, data provider terminal 110 generates, in response to an operation or the like from the first user, a database (DB) storing a collection of data related to the amount of CO₂ emissions (S10). For example, data provider terminal 110 may generate the DB in storage device 201a or may generate the DB in the company’s PC (for example, a server device). The DB stores the average amount of CO₂ emissions per unit, the total amount of CO₂ emissions, and metadata.

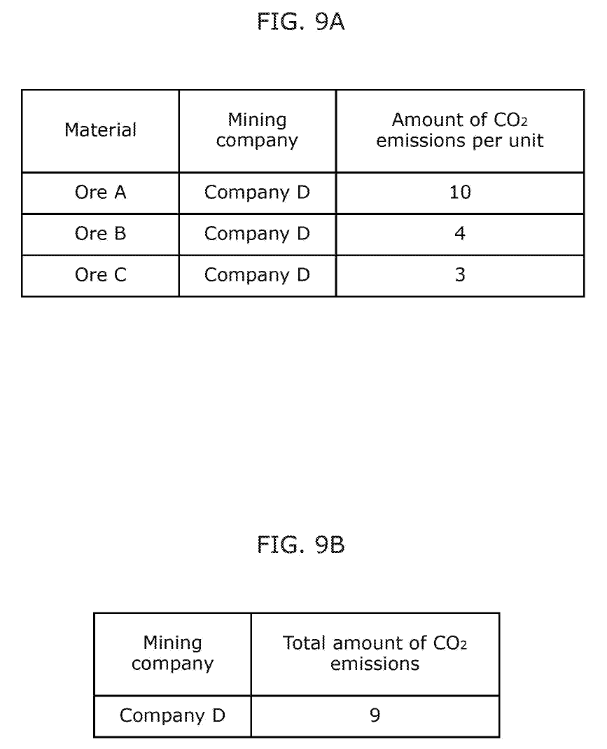

FIG. 9A is a diagram illustrating the amount of CO₂ emissions per unit stored in the database generated in step S10 illustrated in FIG. 8. FIG. 9B is a diagram illustrating the total amount of CO₂ emissions stored in the database generated in step S10 illustrated in FIG. 8. In the present embodiment, the data illustrated in FIG. 9A and the data illustrated in FIG. 9B are examples of the first data. FIG. 9A and FIG. 9B illustrate data obtained via data provider terminal 110 possessed by company D.

As illustrated in FIG. 9A, the data obtained includes materials, a mining company, and the amounts of CO₂ emissions per unit.

As illustrated in FIG. 9B, the data obtained includes a mining company and the total amount of CO₂ emissions.

Note that the data stored in the database is not publicly disclosed.

Referring again to FIG. 8, next, data provider terminal 110 generates metadata of data related to the amount of CO₂ emissions and records the metadata in the database (S20). For example, data provider terminal 110 generates metadata related to the data illustrated in FIG. 9A and FIG. 9B.

Furthermore, determiner 1022 of ledger server 200a determines privacy strength ε of the data related to the amount of CO₂ emissions (S30). Determiner 1022 may determine privacy strength ε based on an attribute of data obtained, for example.

Next, data provider terminal 110: generates generation request transaction data that requests generation of a non-fungible token (NFT) and that includes (i) the address at which the metadata is stored and (ii) a digital signature (also simply referred to as a signature) of mining company D (in other words, a signature generated using a private key of mining company D); and transmits the generation request transaction data to ledger server 200a, and ledger server 200a receives the generation request transaction data (S40). Note that ledger server 200a has, in advance, a public key corresponding to the private key used in step S40 (a public key that forms a key pair with the private key). Obtaining the address at which the metadata is stored is equivalent to obtaining the first data and managing the second data (here, the same as the first data) on a private blockchain.

Note that the information transmitted from data provider terminal 110 and indicating the address at which the metadata is stored is not transmitted to ledger servers 300a etc.

Next, in response to receiving the generation request transaction data transmitted in step S40, ledger server 200a (for example, the ledger manager) verifies the signature of the generation request transaction data. Specifically, ledger server 200averifies the signature included in the generation request transaction data using the public key of mining company D.

Ledger server 200adetermines whether the verification of the signature has been successful, and stores the received generation request transaction data on distributed ledger 1026aif ledger server 200adetermines that the verification of the signature has been successful. Furthermore, ledger server 200agenerates an NFT using the generation request transaction data. Generating an NFT is storing the NFT on distributed ledger 1026a, and includes storing, on distributed ledger 1026a, transaction data indicating generation of an NFT. Metadata of the NFT includes the address at which the data related to the amount of CO₂ emissions is stored.

Next, ledger server 200a transmits the token ID of the generated NFT (ID of the NFT) to data provider terminal 110 (S50). Data provider terminal 110 receives the token ID transmitted. Note that ledger server 200amay transmit the token ID in response to receiving the generation request transaction data.

Note that ledger server 200a obtains data corresponding to FIG. 9A and FIG. 9B from one or more mining companies other than company D as well.

Next, calculator 1023 of ledger server 200acalculates the average amount of CO₂ emissions per unit of each material, based on the amount of CO₂ emissions per unit at each mining company stored in each database (S60). Calculator 1023 calculates the average amount of CO₂ emissions per unit of the material by performing statistical processing, such as averaging, on the raw data of the amount of CO₂ emissions per unit of the material at each mining company. The average amount of CO₂ emissions per unit is an example of the second data.

Next, noise applier 1024 of ledger server 200a applies, to the average amount of CO₂ emissions per unit of each material, noise that is dependent on the average amount calculated in step S60 and privacy strength ε determined in step S30 (S70). In addition, noise applier 1024 of ledger server 200a applies, to the total amount of CO₂ emissions, noise that is dependent on privacy strength ε.

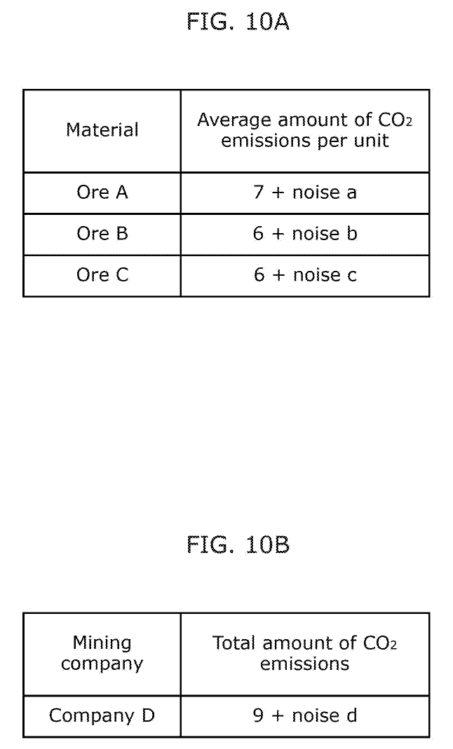

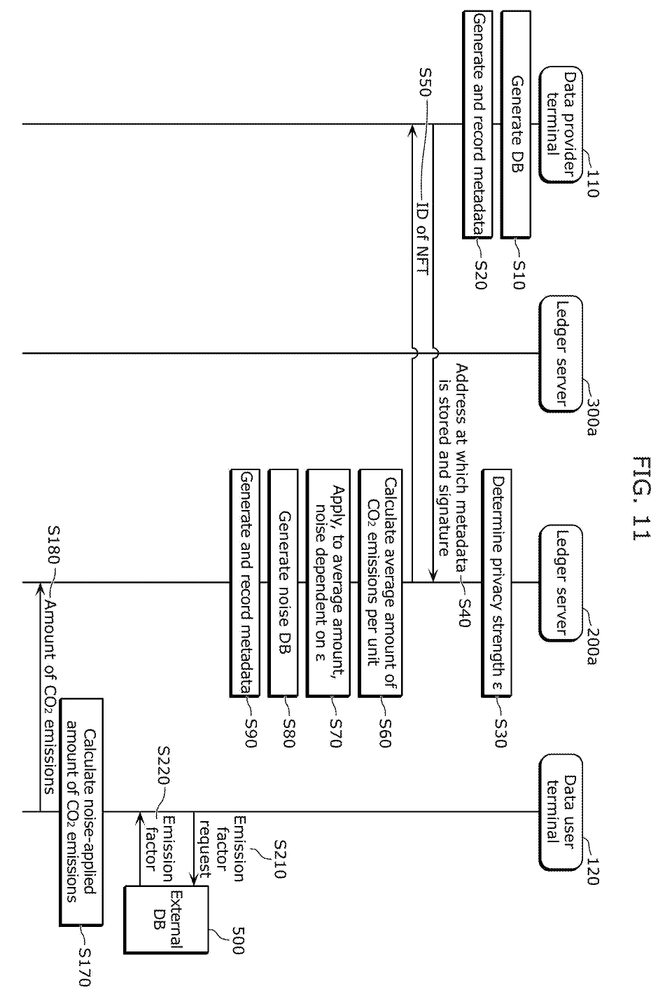

FIG. 10A is a diagram illustrating an example of the average amount of CO₂ emissions per unit to which noise has been applied. FIG. 10B is a diagram illustrating an example of the total amount of CO₂ emissions to which noise has been applied. The data illustrated in FIG. 10A and FIG. 10B are examples of the third data.

As illustrated in FIG. 10A and FIG. 10B, noise applier 1024 applies noise that satisfies differential privacy to the average amount of CO₂ emissions per unit of each material (that is, a statistic). In the example in FIG. 10A, noise applier 1024 applies: noise a to the average amount of CO₂ emissions per unit of ore A; noise b to the average amount of CO₂ emissions per unit of ore B; and noise c to the average amount of CO₂ emissions per unit of ore C. In the example in FIG. 10B, noise applier 1024 applies noise d to the total amount of CO₂ emissions of company D. Noises a through d are calculated using random numbers and are mutually different in value, for example.

Accordingly, even if, for example, the number of mining companies increases or decreases after the public disclosure of the data to which noise satisfying differential privacy has been applied, the data values exhibit a small difference between the periods before and after the increase or decrease in the number of mining companies since the noise satisfying differential privacy has been applied. It is therefore possible to suppress leakage of the amount of CO₂ emissions per unit at company D, for example. This leads to suppressing the leakage of activity data of company D.

Note that applying noise is not limited to adding noise (here, a numerical value), and may be subtracting, multiplying, or dividing the noise, or may be a combination thereof or any other computation.

Referring again to FIG. 8, next, controller 1025 of ledger server 200agenerates a database (noise DB) storing a collection of the data related to the amount of CO₂ emissions to which noise has been applied (S80). For example, the database may be generated in storage device 201a.

Next, controller 1025 generates metadata of the data related to the amount of CO₂ emissions to which noise has been applied, and records the metadata in the noise DB (S90). The noise DB stores the data related to the amount of CO₂ emissions to which noise has been applied and the metadata.

Next, controller 1025: generates generation request transaction data that requests generation of an NFT and that includes (i) the address at which the metadata generated in step S90 (the metadata of the data related to the amount of CO₂ emissions to which noise has been applied) is stored and (ii) a digital signature of ledger server 200a (in other words, a signature generated using a private key of ledger server 200a); and transmits the generation request transaction data to ledger server 300a, and ledger server 300a receives the generation request transaction data (S100). Note that ledger server 300ahas, in advance, a public key corresponding to the private key used in step S100 (a public key that forms a key pair with the private key).

Transmitting to ledger server 300a the address at which the metadata generated in step S90 is stored and managing the address in ledger server 300a is an example of managing, on the public blockchain, the third data that is based on the second data to which noise has been applied.

Next, in response to receiving the generation request transaction data transmitted in step S100, ledger server 300a (for example, the ledger manager) verifies the signature of the generation request transaction data. Specifically, ledger server 300averifies the signature included in the generation request transaction data using the public key of ledger server 200a.

Ledger server 300a determines whether the verification of the signature has been successful, and stores the received generation request transaction data on distributed ledger 1034a if ledger server 300a determines that the verification of the signature has been successful. Furthermore, ledger server 300a generates an NFT using the generation request transaction data. Metadata of the NFT includes the address at which the data related to the amount of CO₂ emissions to which noise has been applied is stored.

Next, ledger server 300a transmits the token ID of the generated NFT (ID of the NFT) to ledger server 200a (S110). Ledger server 200areceives the token ID transmitted. Note that ledger server 300amay transmit the token ID in response to receiving the generation request transaction data.

Next, data user terminal 120 generates emission factor request transaction data that requests generation of an emission factor of a predetermined ore at a predetermined mining company, and transmits the emission factor request transaction data to ledger server 200a (S120). Note that data user terminal 120 may transmit the generated emission factor request transaction data to ledger server 300a. The emission factor is an example of the predetermined information.

Next, when ledger server 200a receives the emission factor request transaction data, ledger server 200agenerates CO₂ emissions request transaction data that requests transmission of data related to the amount of CO₂ emissions, and transmits the CO₂ emissions request transaction data to ledger server 300a (S130).

Next, when ledger server 300areceives the CO₂ emissions request transaction data, ledger server 300atransmits, to ledger server 200a, the data related to the amount of CO₂ emissions to which noise has been applied (S140). For example, ledger server 300atransmits, to ledger server 200a, the noise-applied data related to the amount of CO₂ emissions of each mining company (for example, the data illustrated in FIG. 10A and FIG. 10B).

Next, calculator 1023 of ledger server 200a calculates the emission factor, based on the data received (S150). For example, ledger server 200acalculates the emission factor by calculating the amount of CO₂ emissions of each material based on the second data of each mining company and dividing the calculated amount of CO₂ emissions of each material by the amount of the material mined (that is, activity data). However, the method for calculating the emission factor is not limited to this. For example, in the case where the total amount of CO₂ emissions illustrated in FIG. 10B is the total amount of CO₂ emissions of ore C at company D, the company D’s emission factor of ore C may be calculated by dividing the total amount of CO₂ emissions by the activity data. Note that the activity data may be obtained from company D.

Accordingly, although the emission factor calculated is affected by noise, the privacy of the mining company (for example, company D) can be protected.

Next, controller 1033 of ledger server 200a transmits, to data user terminal 120, the noise-applied emission factor (for example, the third data) calculated based on the data related to the amount of CO₂ emissions to which noise has been applied (S160). The noise-applied emission factor is the emission factor calculated using the data to which noise has been applied.

Next, when data user terminal 120 receives the noise-applied emission factor from ledger server 200a, data user terminal 120 calculates noise-applied amount of CO₂ emissions using the noise-applied emission factor received (S170), and transmits the calculated amount of CO₂ emissions to ledger server 200a (S180). Ledger server 200amay store, in a database, the amount of CO₂ emissions received.

### Variations of Embodiment

Hereinafter, an information processing system according to each variation will be described with reference to FIG. 11 through FIG. 13. Note that the following description will focus on the points different from the embodiment and will omit or simplify the points identical or similar to the embodiment. For example, the configurations of information processing systems according to the variations may be the same as the configuration described in the embodiment, and the description thereof will therefore be omitted. Furthermore, the reference signs of information processing system 10 according to the embodiment will be used in the following description.

### Variation 1 of Embodiment

Hereinafter, information processing system 10 according to the present variation will be described with reference to FIG. 11. FIG. 11 is a sequence diagram illustrating operation (an information processing method) of information processing system 10 according to the present variation. In the present variation, an example in which data user terminal 120 obtains the emission factor from external DB 500 will be described. Note that external DB 500 stores in advance publicly known information such as the industry average of the emission factor.

As illustrated in FIG. 11, data user terminal 120 transmits an emission factor request to external DB 500 (S210).

Next, when external DB 500 receives the emission factor request from data user terminal 120, external DB 500 transmits the emission factor to data user terminal 120 (S220). The emission factor transmitted here is the emission factor to which noise that satisfies differential privacy has been applied (noise-applied emission factor). For example, the emission factor transmitted may be the noise-applied emission factor calculated by ledger server 200a.

### Variation 2 of Embodiment

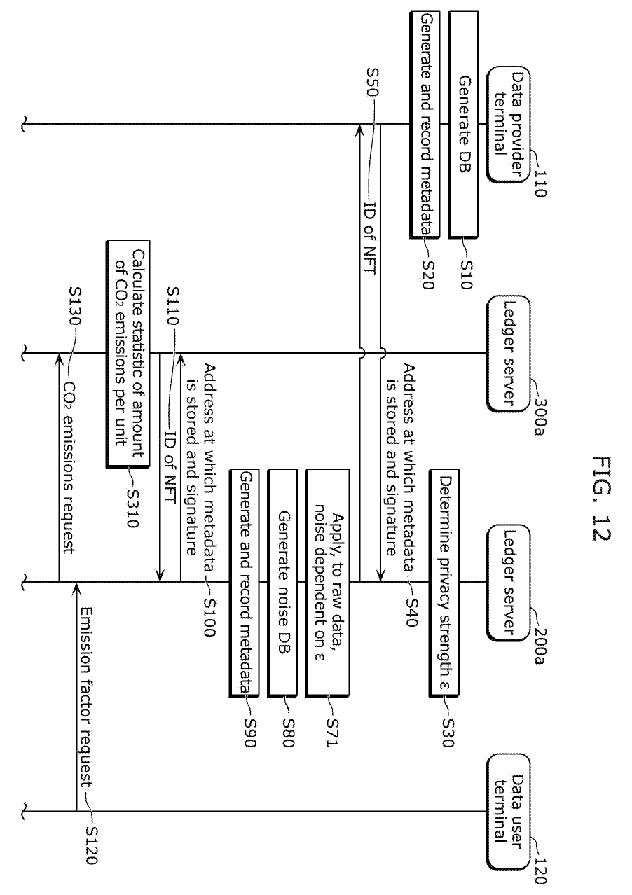

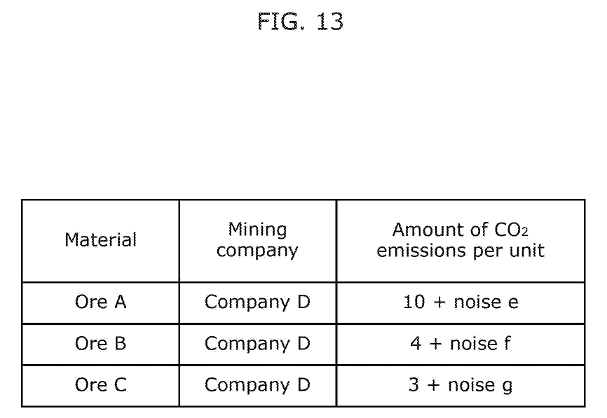

Hereinafter, information processing system 10 according to the present variation will be described with reference to FIG. 12 and FIG. 13. FIG. 12 is a sequence diagram illustrating operation (an information processing method) of information processing system 10 according to the present variation. In the present variation, an example in which noise is applied to data (raw data) related to the amount of CO₂ emissions received from data provider terminal 110 will be described.

As illustrated in FIG. 12, noise applier 1024 of ledger server 200a applies noise dependent on privacy strength ε to data obtained from data provider terminal 110 (for example, the raw data illustrated in FIG. 9A and FIG. 9B, an example of the first data and the second data in the present variation) (S71). The raw data is data that has not undergone any computation (for example, its numerical value has not been changed) after being obtained by ledger server 200a.

FIG. 13 is a diagram illustrating the amount of CO₂ emissions per unit to which noise has been applied in step S71 illustrated in FIG. 12. The data illustrated in FIG. 13 is data obtained by applying noise to the amount of CO₂ emissions per unit of each material at company D.

As illustrated in FIG. 13, noise applier 1024 applies noise that satisfies differential privacy to the amount of CO₂ emissions per unit of each material at company D. In the example of FIG. 13, noise applier 1024 applies: noise e to the amount of CO₂ emissions per unit of ore A; noise f to the amount of CO₂ emissions per unit of ore B; and noise g to the amount of CO₂ emissions per unit of ore C. Noises e through g are calculated using random numbers and are mutually different in value, for example.

Note that the data after the noise application illustrated in FIG. 13 is an example of the second data, and the data before the noise application is an example of the first data.

Referring again to FIG. 12, next, controller 1025 of ledger server 200a generates a database (noise DB) storing a collection of the raw data to which noise has been applied (S80). For example, the database may be generated in storage device 201a.

Next, controller 1025 generates metadata of the raw data to which noise has been applied, and records the metadata in the noise DB (S90).

Furthermore, calculator 1032 of ledger server 300acalculates a statistic of the amount of CO₂ emissions per unit of each mining company stored in each database (S310). Calculator 1032 calculates, as the statistic, the average amount of CO₂ emissions per unit from the amount of CO₂ emissions per unit to which noise has been applied. The statistic calculated in the present variation is an example of the third data.

Various Data Structures and Execution of Smart Contract

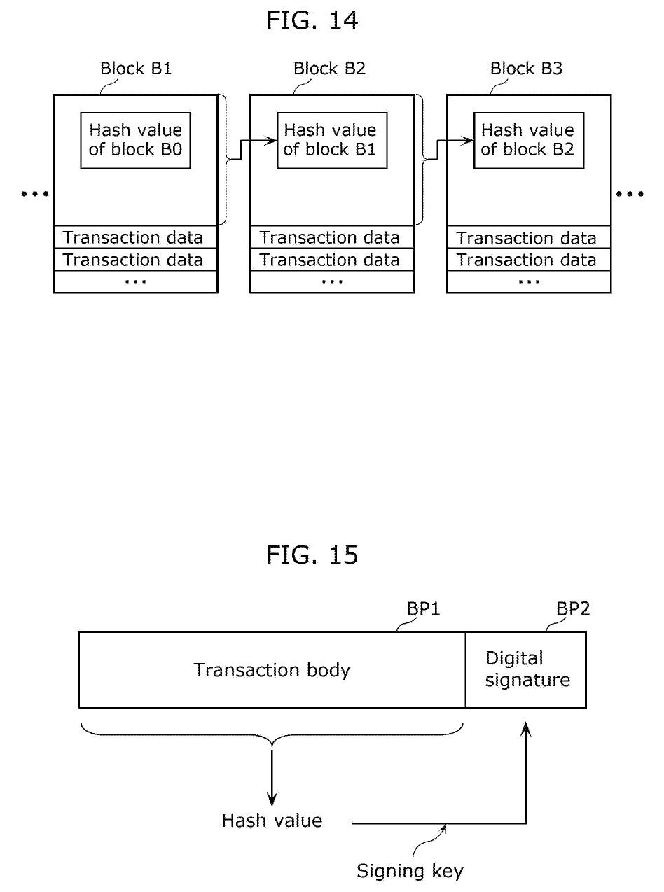

With reference to FIG. 14 through FIG. 18, the data structure of a distributed ledger, the execution of a smart contract, and the data structure of an NFT will be described.

FIG. 14 is an explanatory diagram illustrating the data structure of a blockchain, which is an example of the distributed ledger.

Blocks, which are recording units of a blockchain, are connected to form a chain. Each of the blocks includes a plurality of transaction data items and the hash value of the previous block.

FIG. 14 illustrates blocks B1, B2, and B3 included in the blockchain.

For example, block B2 includes the hash value of block B1, the previous block. The hash value of block B1 is a hash value calculated by computation performed on the content of block B1 according to a hash algorithm.

Block B3 includes, as the hash value of block B2, a hash value calculated from the plurality of transaction data items included in block B2 and the hash value of block B1.

Accordingly, the blockchain has the configuration in which the blocks each including the content of its previous block in the form of a hash value are connected to form a chain. Thus, the blockchain can effectively prevent tampering with recorded transaction data.

If past transaction data is altered (in other words, tampered with), the hash value of the block including the transaction data differs from the value before the alteration. In this case, in order to make the block including the altered transaction data appear authentic, it is necessary to rebuild all the blocks following the block, which includes the altered transaction data, in the distributed ledger stored in each of multiple servers. This task is extremely difficult in reality. These characteristics can make it substantially impossible to tamper with transaction data included in a blockchain.

Note that, to store transaction data on a blockchain, a node generates a block including the transaction data to be stored and executes processing based on a consensus algorithm for the generated block with the other nodes to reach a consensus with them. When the consensus is reached, the node performs control to store the block on the blockchain. In this manner, a plurality of nodes operating in an autonomous and distributed manner can connect a valid block to the blockchain. As the consensus algorithm, practical byzantine fault tolerance (PBFT) may be used, or proof of work (PoW), proof of stake (PoS), or the like may be used. Note that, in the case where Hyperledger fabric is used as an example of a distributed ledger technology, the consensus algorithm need not be executed.

FIG. 15 is an explanatory diagram illustrating a data structure of transaction data.

Transaction data illustrated in FIG. 15 includes transaction body BP1 and digital signature BP2 (also simply referred to as a signature). Transaction body BP1 is the data body included in the transaction data. Digital signature BP2 is generated by encrypting the hash value of transaction body BP1 with a signing key of the creator of the transaction data (in other words, a private key).

Using digital signature BP2 included in the transaction data, a node that has received the transaction data can verify whether transaction body BP1 is valid (in other words, whether it is not tampered with). This can make it substantially impossible to tamper with the data included in transaction body BP1. In addition, by storing the transaction data that has been successfully verified on a blockchain, it is possible to maintain the validity of the transaction data stored on the blockchain.

In the above-described manner, transaction data included in a blockchain are stored on the blockchain in such a manner that the transaction data are linked together using the hash values of the transaction data and the hash values of the blocks. As a result, the transaction data included in the blockchain are stored and maintained in a manner that is effectively tamper-proof. This is an advantage over a database or a distributed database in which a collection of data is simply stored.

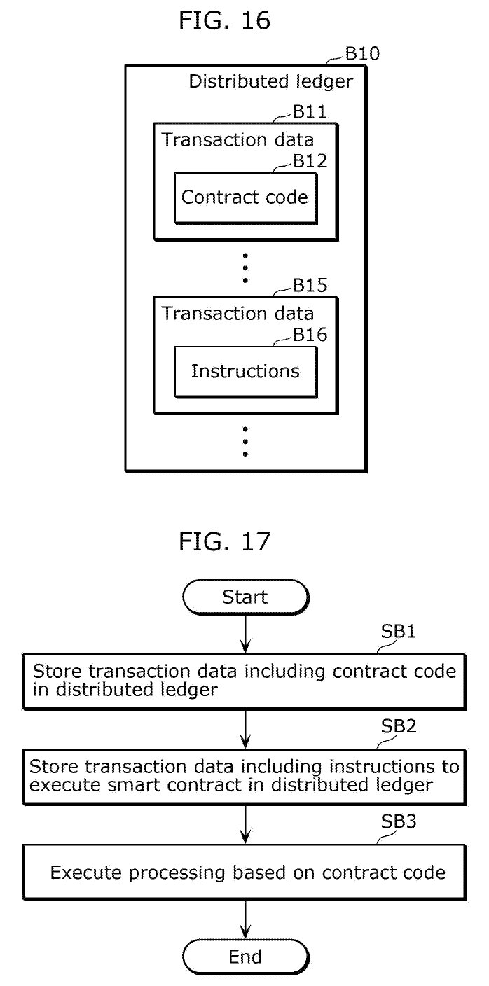

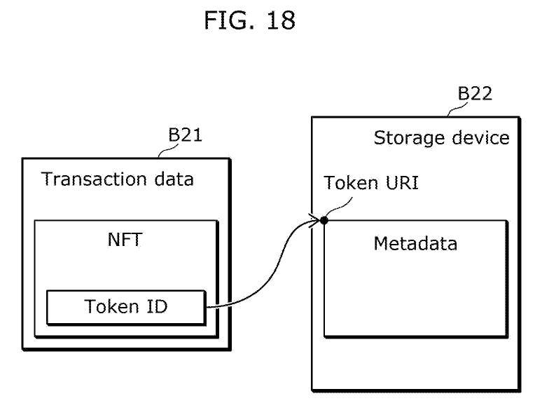

FIG. 16 is an explanatory diagram illustrating transaction data pertaining to execution of a smart contract. FIG. 17 is an explanatory diagram illustrating processing pertaining to execution of a smart contract.

With reference to FIG. 16 and FIG. 17, a series of steps pertaining to the execution of the smart contract using a distributed ledger will be described.

In step SB1, a node stores, on distributed ledger B10, transaction data B11 including contract code B12 in which the processing of the smart contract is written. For example, the node obtains transaction data B11 by receiving transaction data B11 from a certain information processing device through communication or by generating transaction data B11 by itself and stores obtained transaction data B11 on distributed ledger B10. Step SB1 is performed before the execution of the smart contract.

In step SB2, the node stores, on distributed ledger B10, transaction data B15 including instructions B16 to execute the smart contract. For example, the node receives transaction data B15 from a certain information processing device through communication and stores received transaction data B15 on distributed ledger B10.

In step SB3, in response to transaction data B15, which includes instructions B16, being stored on distributed ledger B10 in step SB2, the node reads contract code B12 from distributed ledger B10 and executes the processing based on contract code B12. The result of the processing can be included in transaction data and stored on distributed ledger B10.

By the series of steps, upon receiving transaction data B15 including instructions B16 to execute the smart contract, the distributed ledger system executes the processing according to instructions B16 automatically (in other words, with no manual operations). Thus, it is possible to execute the processing with high efficiency (in other words, at high speed or in a short period of time). Achieving highly efficient processing brings about the advantageous effect of reduction in power consumption. In addition, dispensing with manual operations makes it possible to prevent the tampering with information or misconduct by a person, or human errors beforehand. Furthermore, since the result of the processing executed in such a manner is stored on a blockchain, it is substantially impossible to tamper with the result of the processing.

FIG. 18 is an explanatory diagram illustrating structures of an NFT and metadata. The NFT is a token stored on a distributed ledger. The NFT is a unique token (in other words, a non-fungible token). The NFT is standardized according to, but not limited to, for example, Ethereum Request for Comments (ERC) 721. The NFT may conform to a standard different from ERC 721 or may be non-standard (for example, specific to an organization). Note that although ERC721 is a standard for unique tokens, the NFTs described in the present Specification need not necessarily be unique tokens.

FIG. 18 illustrates transaction data B21 stored on a distributed ledger. Transaction data B21 stores an NFT. The NFT includes a token ID (that is, identification information with which the NFT can be uniquely identified).

The NFT includes metadata. The metadata can be arranged at a location accessible over a network (for example, storage device B22). A token uniform resource identifier (URI) indicating the location of the metadata is calculated using the token ID of the NFT and a predetermined base URI.

Information managed as the NFT may be included in transaction data B21 or may be included in the metadata. The inclusion of the information managed as the NFT in the metadata provides such an advantage that the amount of information included in transaction data B21 (in other words, information included in a blockchain) can be reduced. In this case, the metadata can be considered to contain the actual conditions of the information managed as the NFT. In the case where an image is managed in the form of an NFT, a URL indicating image data on the image can be managed as the NFT.

Note that each of the constituent elements in the embodiment described above may be configured in the form of an exclusive hardware product, or may be implemented by executing a software program suitable for the constituent element. Each of the constituent elements may be implemented by means of a program executor, such as a CPU or a processor, reading and executing the software program recorded on a recording medium such as a hard disk or a semiconductor memory.

### Other Embodiments

Hereinbefore, an information processing method and the like according to one or more aspects have been described based on an exemplary embodiment and Variations 1 and 2 (embodiments and the like), but the present disclosure is not limited to the embodiments and the like. Various modifications of the present embodiment as well as forms resulting from combinations of constituent elements in different embodiments that may be conceived of by those skilled in the art may be included within the present disclosure so long as such modifications and forms do not depart from the essence of the present disclosure.

For example, although the blockchain is used in the above embodiments and the like, the blockchain need not be used. For example, technologies are not limited to blockchain, and distributed ledger technologies such as Hashgraph may also be used.

Further, for example, at least one of the functions related to the noise application performed by ledger server 200a in the above embodiments and the like may be included in a different device such as data provider terminal 110. For example, at least one of the functions of determiner 1022, calculator 1023, and noise applier 1024 of ledger server 200a may be included in data provider terminal 110.

In addition, for example, although the above embodiments and the like have illustrated the example in which information in numerical form is obtained from data provider terminal 110 (that is, the target of noise application is a numerical value), the present disclosure is not limited to this example, and text data, image data, or the like may be obtained. For example, in the case of text data, a character or a character string related to the text data may be applied as noise. Furthermore, for example, in the case of image data, salt-and-pepper noise may be applied as noise.

In addition, for example, the public data in the above embodiments and the like may be the first data per se, or may be information with which the first data can be identified, such as information indicating the database in which the first data is stored.

In addition, for example, in the above embodiments and the like, CO₂ has been described as an example of a greenhouse gas; however, the greenhouse gas is not limited to CO₂. The greenhouse gas may be, for example, methane (CH₄), nitrous oxide (dinitrogen monoxide, N₂O), or fluorocarbons.

In addition, for example, in the above embodiments and the like, the data related to the amount of CO₂ emissions and the data related to the amount of CO₂ emissions to which noise has been applied may be included in transaction data.

In addition, in the above embodiments and the like, the emission factor has been described as an example of the predetermined information; however, the present disclosure is not limited to the emission factor, and data related to the amount of CO₂ emissions or a statistic of the data related to the amount of CO₂ emissions, for example, may be used instead.

In addition, for example, the embodiments and the like have illustrated an example in which a statistic is publicly disclosed on a public blockchain; however, the present disclosure is not limited to this example, and data that has not undergone any statistical processing (for example, the data to which noise has been applied, illustrated in FIG. 13) may be publicly disclosed.

In addition, for example, each device in the above embodiments and the like is specifically a computer system including a microprocessor, ROM, RAM, a hard disk unit, a display unit, a keyboard, a mouse, and the like. A computer program is recorded on the RAM or hard disk unit. Each device achieves the functions thereof by the microprocessor operating in accordance with the computer program. Here, the computer program is constituted by a combination of a plurality of instruction codes that indicate instructions given to a computer to achieve a predetermined function.

In addition, for example, some or all of the constituent elements of the devices in the above embodiments and the like may be implemented by a single large scale integration (LSI) circuit. A system LSI circuit refers to a super multifunctional LSI circuit produced by integrating multiple constituent elements on a single chip, and specifically, refers to a computer system including a microprocessor, ROM, RAM, and the like. A computer program is recorded on the RAM. The system LSI circuit achieves the functions thereof by the microprocessor operating in accordance with the computer program.

The parts of the constituent elements of the above devices may take the form of individual chips, or may be partially or entirely packaged into a single chip.

System LSI circuits herein may also be referred to as integrated circuits (ICs), LSI circuits, super LSI circuits, or ultra LSI circuits depending on the degree of integration. Moreover, the manner in which the circuit integration is achieved is not limited to LSI, and it is also possible to use a dedicated circuit or a generic processor. A field programmable gate array (FPGA) that is programmable after manufacturing of the LSI circuit, or a reconfigurable processor whose connections and settings regarding circuit cells in the LSI circuit are reconfigurable, may be used.

Furthermore, when advancement in semiconductor technology or derivatives of other technologies brings forth a circuit integration technology which replaces LSI, it will be appreciated that such a circuit integration technology may be used to integrate the functional blocks. Application of biotechnology is one such possibility.

In addition, for example, some or all of the constituent elements of the above devices may be configured as a standalone module or an IC card attachable to and detachable from each device. The IC card or module is a computer system including, for example, a microprocessor, ROM, and RAM. The IC card or module may include the above-described super multifunctional LSI. The IC card or module achieves the functions thereof by the microprocessor operating in accordance with a computer program. The IC card or module may be tamperproof.

In addition, for example, the present disclosure may be the methods described above. The present disclosure may be a computer program for implementing these methods with a computer, or a digital signal of the computer program. For example, an aspect of the present disclosure may be a computer program that causes a computer to execute each characteristic step included in the information processing method illustrated in any one of FIG. 8, FIG. 11, FIG. 12, or FIG. 17.

In addition, the present disclosure may also be a computer program or a digital signal recorded on a computer-readable recording medium such as a flexible disk, a hard disk, a CD-ROM, a magneto-optical disk (MO), a digital versatile disc (DVD), a DVD-ROM, a DVD-RAM, a Blu-ray (registered trademark) Disc (BD), or semiconductor memory. The present disclosure may also be the digital signal recorded on these recording media.

In addition, the present disclosure may transmit the computer program or the digital signal via, for example, a telecommunication line, a wireless or wired communication line, a network such as the Internet, or data broadcasting.

In addition, the present disclosure may be implemented as a computer system including (i) memory having the computer program stored therein, and (ii) a microprocessor that operates according to the computer program.

In addition, the program or the digital signal may be implemented by another independent computer system by being recorded on a recording medium and transmitted, or by being transmitted via a network, for example.

In addition, the order in which the steps in the flowchart and the sequence diagrams are executed is a mere example given for specifically describing the present disclosure, and the order may be different from those described above. Furthermore, some of the steps described above may be executed simultaneously (in parallel) with other steps, and some of the steps described above may not be executed.

In addition, the divisions of the functional blocks in the block diagrams are mere examples, and a plurality of functional blocks may be implemented as a single functional block, a single functional block may be divided into a plurality of functional blocks, and some functions may be transferred to other functional blocks. Furthermore, the functions of a plurality of functional blocks having similar functions may be processed by a single hardware or software product in a parallelized or time-divided manner.

In addition, for example, each ledger server according to the above embodiments and the like may be implemented by a single device or may be implemented by a plurality of devices. In the case of implementing a ledger server using a plurality of devices, the constituent elements of the ledger server may be allocated to the plurality of devices in any manner. In the case of implementing a ledger server using a plurality of devices, the method of communication between the plurality of devices is not particularly limited; it may be wireless communication or may be wired communication. The devices may communicate with each other using a combination of wireless communication and wired communication.

### INDUSTRIAL APPLICABILITY

The present disclosure is useful in an information processing device and the like that store data on a distributed ledger.

1. An information processing method comprising:
obtaining first data;
applying noise to second data that is based on the first data; and
managing, on a public blockchain, third data that is based on the second data to which the noise has been applied, and managing the second data on a private blockchain.

2. The information processing method according to claim 1, further comprising:
when transaction data that requests generation of predetermined information that is based on the first data is obtained, generating the predetermined information, based on the third data; and
transmitting the predetermined information generated.

3. The information processing method according to claim 2, wherein
the first data is obtained from a second company upstream of a first company, the first company and the second company being among companies included in a supply chain, and
the transaction data is obtained from the first company.

4. The information processing method according to claim 1, wherein
the noise includes noise that satisfies differential privacy.

5. The information processing method according to claim 1, wherein
the second data is the first data, and
the information processing method further comprises:
performing statistical processing on the second data to which the noise has been applied; and
managing, on the public blockchain, the second data to which the noise has been applied and on which the statistical processing has been performed, the second data being managed as the third data.

6. The information processing method according to claim 1, further comprising:
calculating the second data by performing statistical processing on the first data.

7. The information processing method according to claim 1, wherein
the first data includes data related to an amount of greenhouse gas emissions.

8. An information processing device comprising:
an obtainer that obtains first data;
a noise applier that applies noise to second data that is based on the first data; and
a controller that performs control to manage, on a public blockchain, third data that is based on the second data to which the noise has been applied, and manage the second data on a private blockchain.

9. A non-transitory computer-readable recording medium having recorded thereon a program for causing a computer to execute the information processing method according to claim 1.
